(19) United States
(12) Patent Application Publication
(10) Pub. No.: US 2010/0050584 A1
(43) Pub. Date: Mar. 4, 2010

(54) In-Ground Lawn Mowing Apparatus

(76) Inventor: Timothy J. Whitehead, Centerville, MA (US)

Correspondence Address: Russ Weinzimmer, 614 Nashua Street, Suite 53, Milford, NH, 03055, US

(21) Appl. No.: 12/202,254

(22) Filed: Aug. 30, 2008

(51) Int. Cl. A01D 34/416

(52) U.S. Cl. 56/10.2 A

(57) ABSTRACT

An in-ground lawn cutting device is disclosed that uses a rotating cord to trim and mulch grass much faster than conventional means. A spool rotates at high speed and extends a weighted cord that cuts grass within a circle. The spool height can be slowly lowered to mulch grass as it cuts. When finished, the cord is retracted and the spool can be lowered at least partly below grade. The device can detect the height of surrounding vegetation and/or the presence of nearby obstructions through reflection or transmission between devices of LASER or other light. The device can issue an audible and/or visual alarm when an obstruction is detected, and/or immediately before and during the cutting. In some embodiments the device can be tilted, the cutting cord can be adjusted in length, and/or a controller is included. The controller can be wireless, hand-held, and/or controlled by a hand-held wireless remote.

### FIELD OF THE INVENTION

The invention generally relates to landscaping maintenance, and more specifically to lawn mowing.

### BACKGROUND OF THE INVENTION

Lawns are very common in landscaping, and are highly prevalent in areas surrounding homes, apartment buildings, highway medians, sports fields, golf courses, and other landscaping venues. Lawns can include many types of grasses and other vegetation, and most lawns need to be periodically trimmed so as to maintain them at a uniform height, thereby maintaining both their attractiveness and their ease and comfort of use.

A profound amount of manual labor is expended each year trimming lawns and dealing with the resultant clippings. Many lawns need to be trimmed every one to two weeks, depending on the type or types of vegetation included. So-called “self propelled” lawn mowers and riding lawn mowers make the task less arduous by reducing the physical effort required of the operator. However, the required operator time is not reduced by these approaches. “Mulching” lawn mowers produce clippings that are sufficiently fine so that they quickly sink below the surface of the cut lawn and rapidly decompose. However, the time required to mow the lawn remains unchanged. Very large lawn mowers allow lawns to be trimmed more quickly, and therefore require less operator time, but they are very costly and require significant storage space, making them practical only for professional lawn cutting services.

Robotic lawn mowers have been proposed, which are essentially self-propelled lawn mowers that are guided by a computer and some sort of position determining system. However, these devices do not decrease the time required to trim a lawn, and are not widely used due to the practical difficulties associated with their programming, customization to a given lawn environment, and maintenance.

### SUMMARY OF THE INVENTION

An in-ground lawn cutting device is claimed that uses a weighted cutting cord extended from a rotating spool to automatically trim and mulch surrounding vegetation in a small fraction of the time required by conventional means.

The in-ground lawn cutting device includes a housing that can be buried at least partly below grade, a rotatable spool that can be positioned at an elevation above grade when the housing is buried at least partly below grade, a rotation motor located in the housing and attached to the rotatable spool, the rotation motor being able to cause the rotatable spool to rotate, and a cutting cord with a weight attached to a distal end of the cord, the weighted distal end being extendable from the rotatable spool while the rotatable spool is rotating, thereby sweeping the cutting cord over a substantially disk-shaped area and trimming the height of vegetation located within the area.

In preferred embodiments, the in-ground lawn cutting device also includes a cutting height apparatus that is able to increase and decrease the elevation of the rotatable spool. In some of these embodiments, the rotatable spool can be positioned at least partly below grade when the rotatable spool is not rotating, and in some of these embodiments the elevation above grade can be slowly decreased while the rotatable spool is rotating and the cutting cord is extended, so as to cut surrounding vegetation into small segments as the height of the surrounding vegetation is reduced. In some of these embodiments the cutting height apparatus is a cutting height motor that is able to vertically reposition the rotation motor, thereby also vertically repositioning the rotatable spool.

In some preferred embodiments the in-ground lawn cutting device also includes an optical stage that contains a light source and a light detector that are able to detect the height of surrounding vegetation and/or the presence of nearby obstructions. In some of these embodiments the optical stage is located above and fixed to the rotating spool, and in some of these embodiments the light source is a LASER. In other of these embodiments the light detector is able to detect light transmitted by the light source and reflected from surrounding vegetation and/or obstructions near the in-ground lawn cutting device. And in still other of these preferred embodiments the light detector is able to detect light transmitted by other in-ground lawn cutting devices when the light is not intercepted by surrounding vegetation or obstructions near the in-ground lawn cutting device.

In various preferred embodiments the in-ground lawn cutting device includes a tilt apparatus that is able to tilt the plane of the disk-shaped area swept out by the lawn cutting device, and in some of these preferred embodiments the tilt apparatus is able to tilt the rotation axis of the rotation motor and the rotatable spool in relation to the housing.

In preferred embodiments the in-ground cutting device includes an alarm stage that is able to transmit at least one of an audibly detectable alarm signal and a visually detectable alarm signal to persons and animals near the in-ground cutting device. In some of these embodiments the alarm stage transmits an alarm during a time interval immediately prior to extension of the cutting cord, and in some of these embodiments the alarm stage transmits an alarm whenever the cutting cord is extended. In still other of these embodiments where the in-ground cutting device also includes an optical stage that is able to detect the presence of nearby obstructions, the alarm stage transmits an alarm when an obstruction is detected.

In some preferred embodiments the length of the cutting cord is adjustable, so as to adjust the radius of the substantially disk-shaped area over which the cutting cord is swept.

In various preferred embodiments the in-ground cutting device also includes a controller that is able to initiate periodic determinations of vegetation height surrounding an in-ground cutting device, initiate detection of obstructions near an in-ground cutting device, issue an alarm when an obstruction is detected within a cutting area, initiate cutting of vegetation according to periodic time intervals and/or a maximum vegetation height, control a plurality of in-ground cutting devices, and when an obstruction is detected, provide identifying information regarding the cutting device that is closest to the obstruction. Some of these embodiments also include a hand-held remote control that can control at least some functions of the controller, and in some of these embodiments the controller is wireless and/or hand-held.

### BRIEF DESCRIPTION OF THE DRAWINGS

The invention will be more fully understood by reference to the detailed description, in conjunction with the following figures, wherein:

FIG. 1A is a sectional view of a preferred embodiment showing the spool positioned above grade and the cutting cord extended;

FIG. 1B is a sectional view of the embodiment of FIG. 1A at right angles to the sectional view of FIG. 1A;

FIG. 1C is a sectional view of the embodiment of FIG. 1A with the cutting cord not extended and the spool positioned partly below grade;

FIG. 2 is a functional diagram showing how a plurality of cutting devices can be positioned in the ground so as to cut a lawn within a rectangular area;

FIG. 3 is a sectional view of the embodiment of FIG. 1A, illustrating optical detection of a nearby obstruction;

FIG. 4 is a sectional close-up view of a combined optical and alarm stage from a preferred embodiment;

FIG. 5 is a functional diagram showing transmission of light from one cutting device to a plurality of nearby cutting devices, so as to detect the height of vegetation between the devices; and

FIG. 6 is a perspective view of a cutting device controller from a preferred embodiment.

### DETAILED DESCRIPTION OF PREFERRED EMBODIMENTS

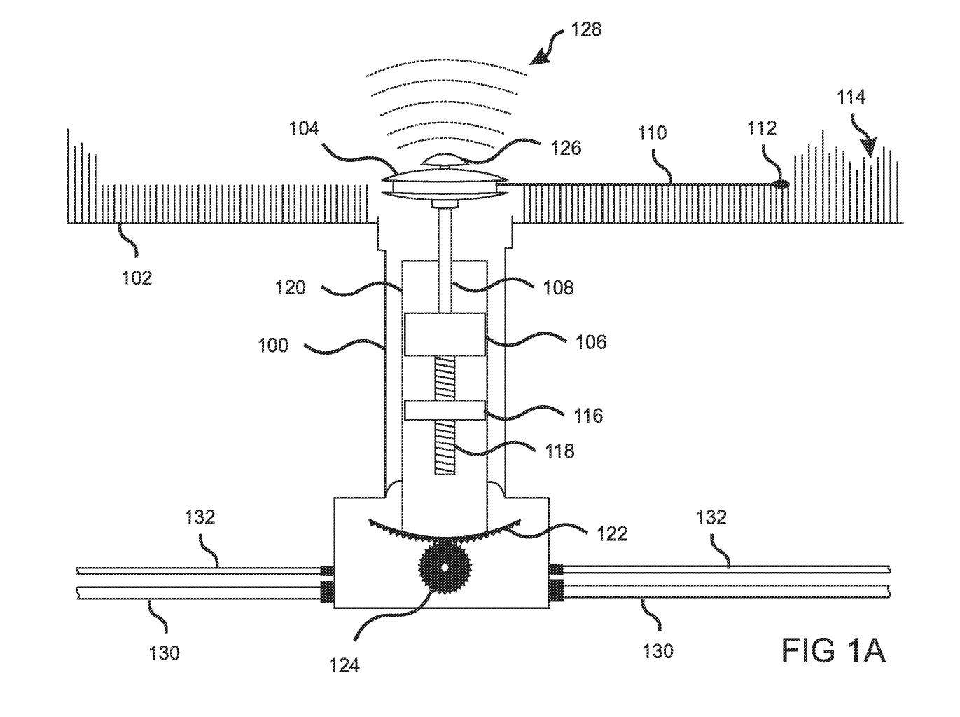

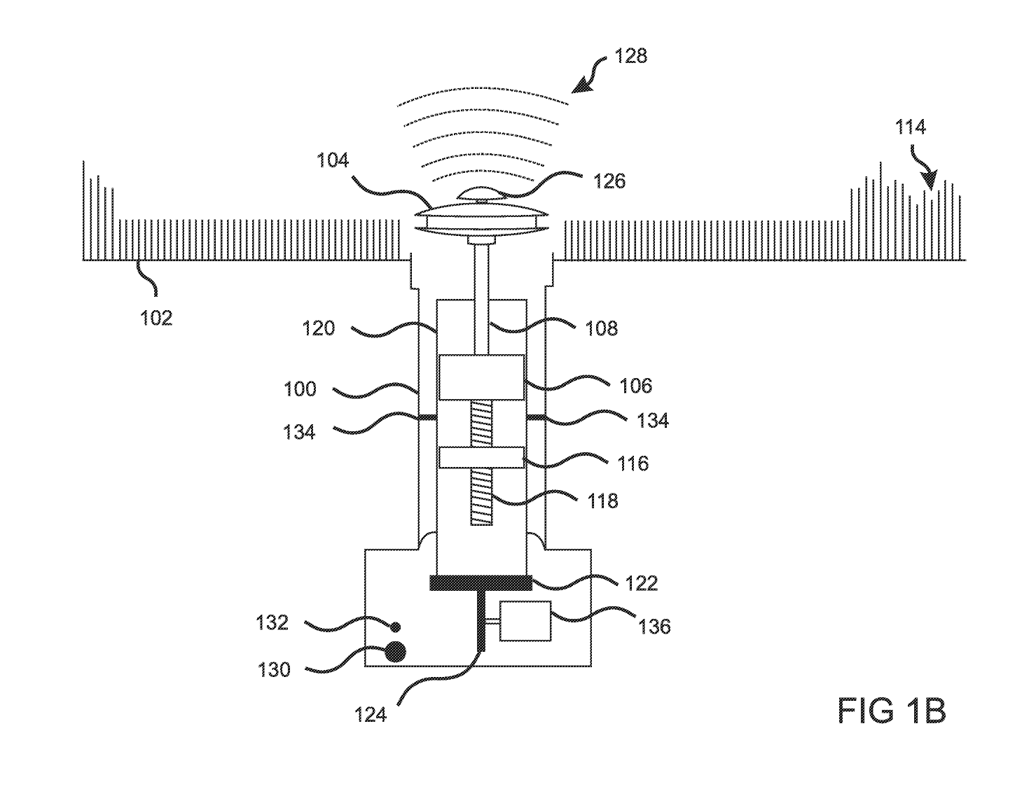

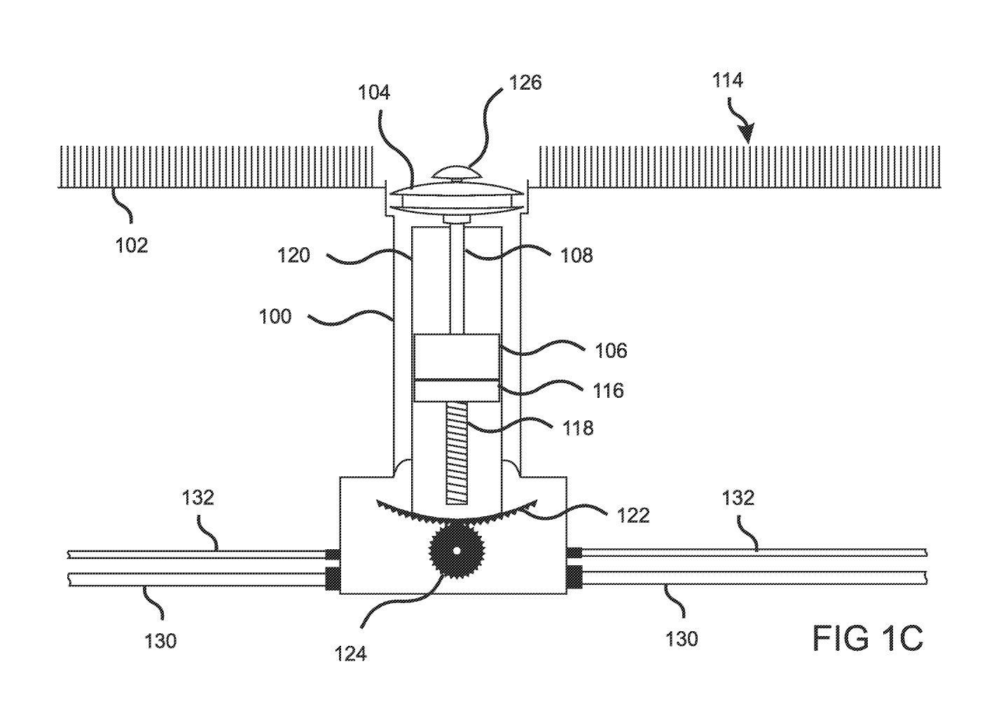

With reference to FIG. 1, the cutting device includes a housing 100 that is buried in the ground, mostly or entirely below grade 102. In preferred embodiments the housing 100 is between 8 inches and two feet in length, and between 4 and 5 inches in diameter. A rotatable spool 104 is extendable from the housing 100 to an elevation above grade 102, and a rotation motor 106 located in the housing 100 and attached to the rotatable spool 104 is able to cause the rotatable spool to rotate very rapidly. In the embodiment of FIG. 1A, the rotation motor 106 is connected to the spool 104 by a shaft 108 that is coaxial with the rotation motor 106 and the spool 104.

A cutting cord 110 with a weight 112 attached to its distal end can be extended from the rotatable spool 104 while the rotatable spool 104 is rotating, so as to sweep the cutting cord 110 over a substantially disk-shaped area surrounding the housing and thereby trim the height of any grass or other cuttable vegetation 114 located within the area. In preferred embodiments, the cutting cord 110 is a thin braded metal line, approximately 0.030 mm in thickness, that extends itself by centrifugal force to a preset length.

In the embodiment of FIG. 1A, the cutting device includes a cutting height apparatus 116 that is able to raise and lower the elevation of the rotating spool 104. In this embodiment, the cutting height apparatus 116 is a motor that controls the height of a threaded shaft 118 connected to the base of the rotation motor 106, thereby lifting and lowering the rotation motor 106, the connecting shaft 108, and the rotatable spool 104. In various embodiments, the maximum height to which the spool 104 can be raised is between 16 inches and 24 inches.

In this embodiment the cutting height apparatus 116, the threaded shaft 118 and the rotation motor 106 are all contained inside of an inner housing 120 with a curved, toothed bottom 122 that mates with a tilting gear 124 located below the inner housing 120. The tilting gear can 124 move the base 122 of the inner housing 120 back and forth, causing the entire assembly contained inside of the inner housing 120 to tilt, and thereby causing the substantially disk-shaped cutting area of the cutting cord to tilt. This feature can be used to compensate for an imperfectly vertical installation, shifting of the ground after installation, or a sloping grade. In some preferred embodiments the inner housing 120 and associated toothed bottom 122 and tilting gear 124 can be rotated about the vertical axis by an arbitrary angle, thereby allowing the inner housing 120 to be tilted in any desired direction.

The preferred embodiment of FIG. 1A also include a module 126 mounted above the spool 104 that contains a light source, a light detector, and a speaker that can emit an audible alarm signal 126. In this embodiment, the alarm signal is active whenever the cutting cord 110 is extended. A set of power cables 130 bring power to the unit and carry it on to other units, and a set of signal cables 132 convey signals between the cutting devices and between the cutting device and a control unit. In preferred embodiments, these cables 130, 132 can be installed by a pipe-laying machine.

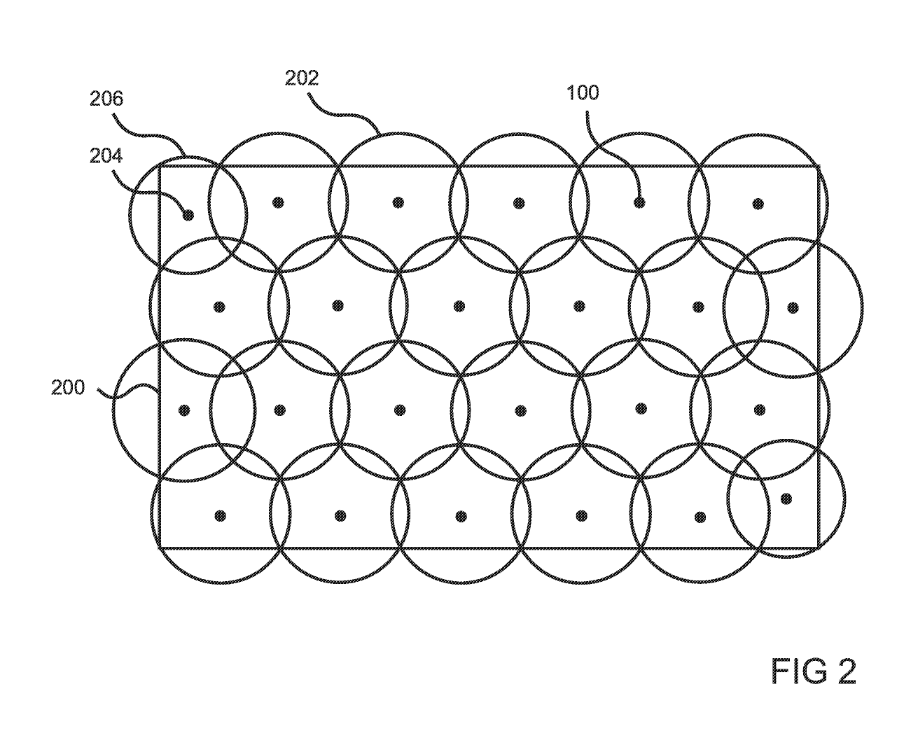

FIG. 2B is a sectional view of the embodiment of FIG. 1A through a section taken at 90 degrees to the section of FIG. 1A. In FIG. 1B the pivots 134 that support the inner housing 120 can be seen, as well as the tilting motor 138 that can rotate the tilting gear 124 so as to tilt the inner housing 120. FIG. 2C is a sectional view of the embodiment of FIG. 1A through the same section as FIG. 1A, but with the cutting cord 110 not extended (i.e. retracted into the spool 104), and with the spool 104 lowered so as to be partly below grade. The alarm is no longer sounding because the cutting operation is finished and the cutting cord 110 has been retracted into the spool 104.

FIG. 2 is a functional diagram that illustrates a plurality of cutting devices 100 arranged within a rectangular lawn 200 so as to cut the grass of the lawn 200 using as few cutting devices as possible. Most of the cutting devices 100 are arranged in a classic “hexagonal” pattern that creates a repeated pattern of hexagons with each hexagon including a cutting device 100 at each vertex and one in the center. The size of the hexagons is determined by the diameter of the circular cutting area 202 of each cutting device 100. In preferred embodiments the circular area cut by a single cutting device can be varied from 5 inches to 25 feet. Near the boundaries of the lawn 200, the locations 204 and cutting circle diameters 206 of some of the cutting devices are altered so as to minimize projection of the cutting circles 202, 206 beyond the lawn 200. While FIG. 2 illustrates the principles underlying placement of the cutting devices within a lawn, in practice the cutting devices would be placed slightly closer to each other to ensure overlap of the cutting circles at all points. In some embodiments the rotation of the cutting cords 110 is synchronized and/or the heights of the spools 104 are varied so as to avoid collisions between the cutting cords.

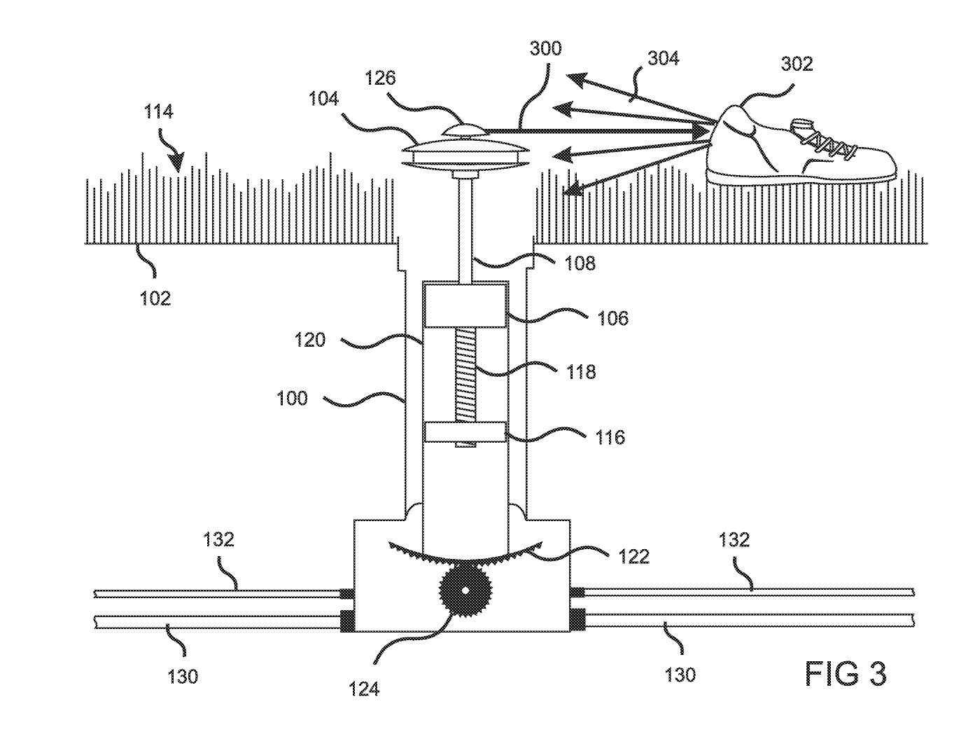

As was mentioned above, the preferred embodiment of FIG. 1A includes a module 126 mounted above the spool 104 that contains a light source and a light detector. In FIG. 3, the module 126 is shown emitting a LASER beam 300 that strikes an obstruction 302 (shown in the drawing as a shoe). Scattered light 304 from the object 302 is detected by the module 126, causing the system to abort the cutting operation.

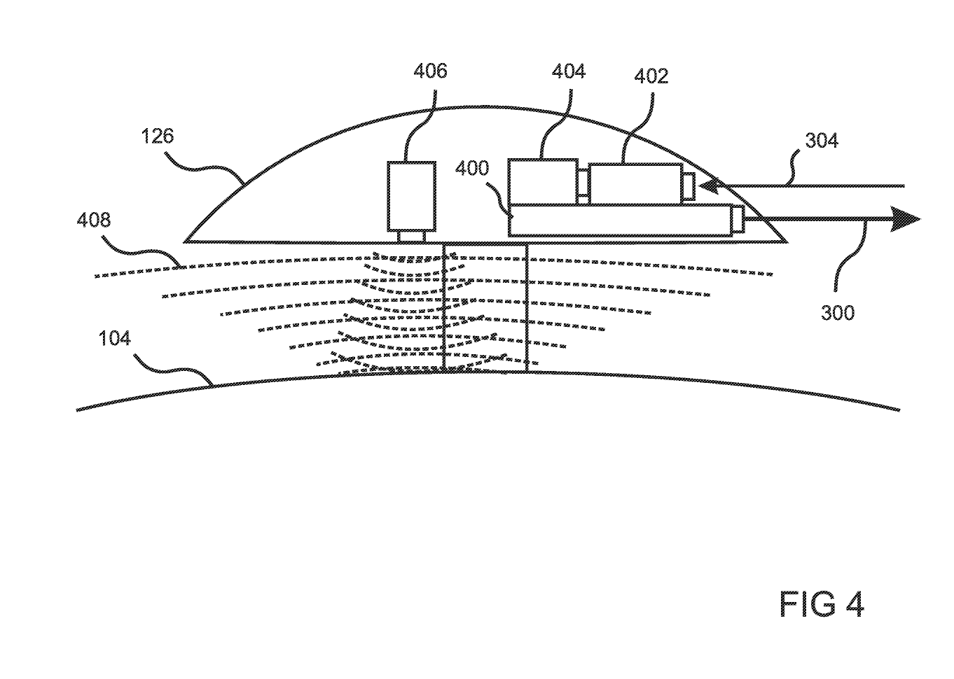

FIG. 4 presents a close-up cutaway of the module 126 mounted in FIG. 1A above the spool 104. A LASER 400 light source emits a beam of light 300 through the transparent cover of the module 126. The LASER light 300 strikes an obstruction (302 in FIG. 3), and some of the light 304 is reflected back to the module 126 and enters a filter 402 that excludes light from sources other than the LASER 400. The light then enters a light detector 404 which generates a signal that is transmitted to a controller, causing the lawn cutting cycle to be aborted. A sound generating device 406 is also located inside of the module 126. When the obstruction is detected, the sound generating device 406 generates sound 408, which is reflected off of the top of the spool and is easily heard by an operator who can then quickly locate which cutting device 100 has sensed the object, and can therefore quickly locate and remove the object from the cutting zone. During an active lawn cutting cycle, the all of the sound emitting devices 406 in a plurality of cutting devices 100 emit sound, so as to warn anyone in the area that the lawn cutting system is active.

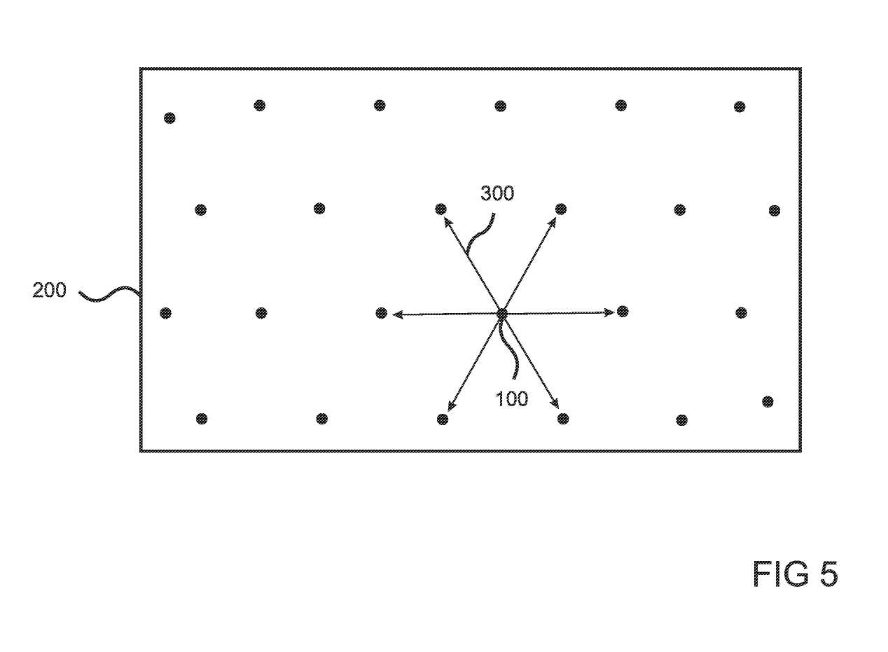

In some preferred embodiments, the height of the grass is detected by cutting devices 100 using reflected light, as described above. In other preferred embodiments, light emitted by one cutting device 100 is detected by neighboring devices 100, providing a method that is more sensitive to very small objects such as blades of grass. FIG. 5 presents a functional diagram of the embodiment of FIG. 2, where the cutting cords 110 are not extended and one of the cutting devices 100 is transmitting light to its nearest neighbors. As is illustrated in the figure, when the cutting devices 100 are arranged in a “hexagonal” pattern each cutting device 100 can obtain up to six grass height measurements using this method, but obstructions 302 that do not lie between cutting devices 100 cannot be detected in this way.

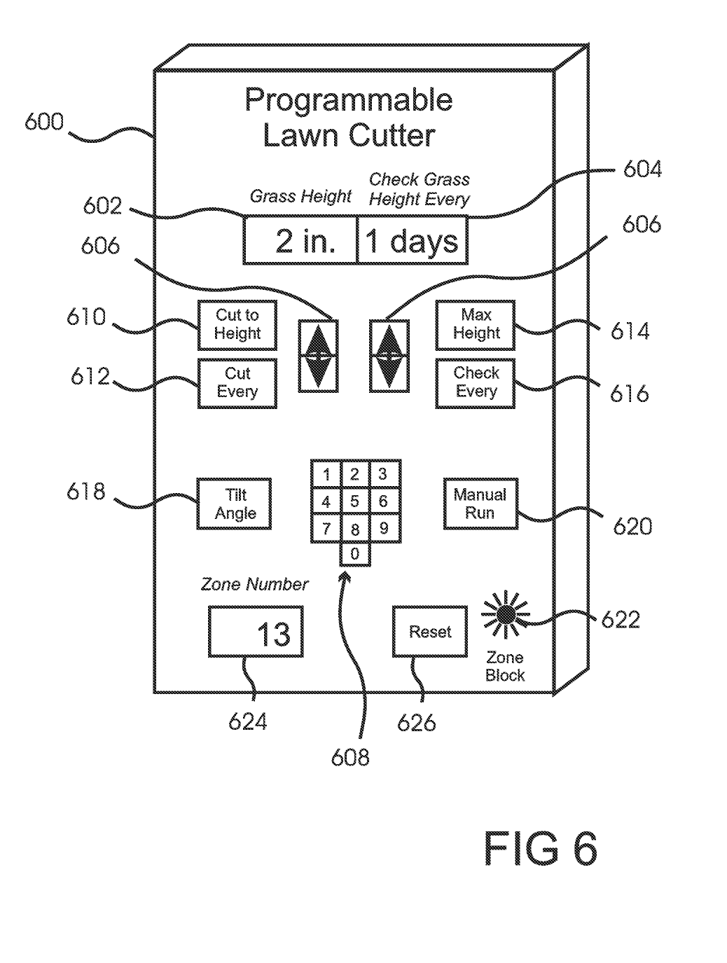

FIG. 6 illustrates a controller 600 used in a preferred embodiment to control a plurality of cutting devices 100. The controller 600 includes a display that indicates the most recently measured height of the grass 602 and the interval at which the height is measured 604. These parameters, as well as other parameters, can be varied either by pushing on “up” and “down” arrows 606, so as to increase or decrease the values, or numbers can be directly entered via a numeric keypad 608. Additional buttons are provided that temporarily display parameters and allow them to be set. The height to which the grass is to be cut 610 can be selected, and a time interval 612 (such as bi-weekly) and/or a maximum grass height 614 can be selected as criteria for initiating a cutting cycle. The frequency with which the height of the grass is to be checked 616 can also be set, as well as the tilt angle of the cutting device 618. If desired, a cutting cycle can also be manually initiated 620.

In this preferred embodiment, when a cutting cycle is initiated a loud, shrill, audible warning signal is emitted from the cutting devices before cutting begins, so as to warn people in the area and frighten away any animals or birds. The audible warning signal is continued throughout the cutting process. After the warning signal has sounded for approximately 10 seconds, the spools on the cutting devices are raised to a few inches above the grass level and the optical modules are rotated by 3600 to check the cutting zones for any remaining obstructions 302, such as people, pets, toys, birds, rocks, and such like. If an obstruction 302 is detected, cutting is aborted, a “zone block” error light 622 is illuminated on the controller 600, and a display 624 on the controller 600 indicates in which cutting zone the obstruction 302 was detected. When the obstruction 302 has been removed the zone block status is reset 626.

Once the cutting zones are determined to be free of obstructions 302, rotation of the spools 104 begins, and the cutting cords 110 are extended. The spools 104 are then slowly lowered, cutting the grass 114 into very short segments, typically less than 1/16 inch in length, that quickly settle into the grass and decompose. When the cutting cords 110 reaches the specified “cut-to” height 610, the rotation of the spools 104 is stopped, the cutting cords 110 are retracted into the spools 104, and the spools 104 are lowered at least partly below grade 102.

In the embodiment of FIG. 6, the controller 600 communicates with the cutting devices 100 through in-ground communication cables 132. In some embodiments, most or all of the functions of the control panel 600 are also available on a wireless, hand-held remote control. And in some preferred embodiments, communication with the cutting devices is wireless 100, and/or the cutting devices 100 are controlled by a fixed controller 600, a hand-held remote, or both.

Other modifications and implementations will occur to those skilled in the art without departing from the spirit and the scope of the invention as claimed. Accordingly, the above description is not intended to limit the invention except as indicated in the following claims.

What is claimed is:

1. An in-ground lawn cutting device, comprising:
a housing that can be buried at least partly below grade;
a rotatable spool that can be positioned at an elevation above grade when the housing is buried at least partly below grade;
a rotation motor located in the housing and attached to the rotatable spool, the rotation motor being able to cause the rotatable spool to rotate; and
a cutting cord with a weight attached to a distal end of the cord, the weighted distal end being extendable from the rotatable spool while the rotatable spool is rotating, thereby sweeping the cutting cord over a substantially disk-shaped area and trimming the height of vegetation located within the area.

2. The in-ground lawn cutting device of claim 1, further comprising a cutting height apparatus that is able to increase and decrease the elevation of the rotatable spool.

3. The in-ground lawn cutting device of claim 2, wherein the rotatable spool can be positioned at least partly below grade when the rotatable spool is not rotating.

4. The in-ground lawn cutting device of claim 2, wherein the elevation above grade can be slowly decreased while the rotatable spool is rotating and the cutting cord is extended, so as to cut surrounding vegetation into small segments as the height of the surrounding vegetation is reduced.

5. The in-ground lawn cutting device of claim 2, wherein the cutting height apparatus is a cutting height motor that is able to vertically reposition the rotation motor, thereby also vertically repositioning the rotatable spool.

6. The in-ground lawn cutting device of claim 1, further comprising an optical stage that includes a light source and a light detector and is able to detect at least one of the height of surrounding vegetation and the presence of nearby obstructions.

7. The in-ground lawn cutting device of claim 6, wherein the optical stage is located above and fixed to the rotating spool.

8. The in-ground lawn cutting device of claim 6, wherein the light source is a LASER.

9. The in-ground lawn cutting device of claim 6, wherein the light detector is able to detect light transmitted by the light source and reflected from at least one of surrounding vegetation and obstructions near the in-ground lawn cutting device.

10. The in-ground lawn cutting device of claim 6, wherein the light detector is able to detect light transmitted by other in-ground lawn cutting devices when the light is not intercepted by one of surrounding vegetation and obstructions near the in-ground lawn cutting device.

11. The in-ground lawn cutting device of claim 1, further comprising a tilt apparatus that is able to tilt the plane of the disk-shaped area swept out by the lawn cutting device.

12. The in-ground lawn cutting device of claim 11, wherein the tilt apparatus is able to tilt the rotation axis of the rotation motor and the rotatable spool in relation to the housing.

13. The in-ground cutting device of claim 1, further comprising an alarm stage that is able to transmit at least one of an audibly detectable alarm signal and a visually detectable alarm signal to persons and animals near the in-ground cutting device.

14. The in-ground cutting device of claim 13, wherein the alarm stage transmits an alarm during a time interval immediately prior to extension of the cutting cord.

15. The in-ground cutting device of claim 13, wherein the alarm stage transmits an alarm whenever the cutting cord is extended.

16. The in-ground cutting device of claim 13, wherein the in-ground cutting device includes an optical stage that is able to detect the presence of nearby obstructions, and the alarm stage transmits an alarm when an obstruction is detected.

17. The in-ground cutting device of claim 1, wherein an extension length of the cutting cord is adjustable, so as to adjust the radius of the substantially disk-shaped area over which the cutting cord is swept.

18. The in-ground cutting device of claim 1, further comprising a controller that is able to at least one of:
initiate periodic determinations of vegetation height surrounding an in-ground cutting device;
initiate detection of obstructions near an in-ground cutting device;
issue an alarm when an obstruction is detected within a cutting area;
initiate cutting of vegetation according to at least one of periodic time intervals and a maximum vegetation height;
control a plurality of in-ground cutting devices; and
when the controller is controlling a plurality of cutting devices and an obstruction is detected, provide identifying information regarding the cutting device that is closest to the obstruction.

19. The in-ground cutting device of claim 18, further comprising a wireless, hand-held remote control that can control at least some functions of the controller.

20. The in-ground cutting device of claim 18, wherein the controller is at least one of wireless and hand-held.
